(19) United States
(12) Patent Application Publication
(10) Pub. No.: US 2025/0018428 A1
(43) Pub. Date: Jan. 16, 2025

(54) VIBRATING DEVICE

(71) Applicant: TDK Corporation, Tokyo (JP)

(72) Inventor: Takashi KATO, Tokyo (JP)

(73) Assignee: TDK Corporation, Tokyo (JP)

(21) Appl. No.: 18/632,503

(22) Filed: Apr. 11, 2024

(30) Foreign Application Priority Data
Jul. 10, 2023 (JP) 2023-112865

(51) Int. Cl. B06B 1/06

(52) U.S. Cl. CPC B06B 1/0648

(57) ABSTRACT

A vibrating device includes a vibrator including a piezoelectric element, and a vibrating body fixed so as to overlap the vibrator via a fixing portion. The fixing portion has a first fixing portion located on a center side and second fixing portions located outside the first fixing portion in plan view of the vibrator and the vibrating body. Deformation tolerance of the vibrator and the vibrating body by the second fixing portions is larger than deformation tolerance of the vibrator and the vibrating body by the first fixing portion.

### CROSS-REFERENCE TO RELATED APPLICATIONS

This application is based upon and claims the benefit of priority from Japanese Patent Application No. 2023-112865, filed on Jul. 10, 2023, the entire contents of which are incorporated herein by reference.

### TECHNICAL FIELD

The present disclosure relates to a vibrating device.

### BACKGROUND

As a conventional vibrating device, for example, there is a transparent speaker described in Japanese Unexamined Patent Publication No. H4-70100. The transparent speaker is configured by fixing a piezoelectric element having transparent electrodes on both surfaces to a vibrating body in a unimorph type or a bimorph type. A lead portion of the transparent electrode on a front surface goes around to a back surface in a state of being electrically insulated from the transparent electrode on the back surface. A pair of lead wires made of a conductive transparent resin or a transparent electrode material are disposed on the vibrating body, and are electrically coupled to each of the front and back transparent electrodes.

### SUMMARY

In general, the vibrating device using the piezoelectric element as described above is not good at outputting vibration having a long wavelength (that is, low sound). In order to increase the output of the vibration having the long wavelength, it is conceivable to devise a coupling structure between the piezoelectric element and the vibrating body, but it is also necessary to consider a transmission loss of vibration between the piezoelectric element and the vibrating body.

The present disclosure has been made to solve the above problem, and an object of the present disclosure is to provide a vibrating device capable of outputting vibration having a long wavelength while avoiding a transmission loss of vibration between a piezoelectric element and a vibrating body.

A vibrating device according to one aspect of the present disclosure includes: a vibrator including a piezoelectric element; and a vibrating body fixed so as to overlap the vibrator via a fixing portion, in which the fixing portion has a first fixing portion located on a center side and second fixing portions located outside the first fixing portion in plan view of the vibrator and the vibrating body, and deformation tolerance of the vibrator and the vibrating body by the second fixing portions is larger than deformation tolerance of the vibrator and the vibrating body by the first fixing portion.

In this vibrating device, by suppressing the deformation tolerance of the first fixing portion on the center side, vibration generated by the vibrator can be transmitted to the vibrating body in a state where a loss is suppressed. On the other hand, since the deformation tolerance of the outer second fixing portion is secured, the vibrating body can be vibrated in a wider range. As a result, even in a case where the vibrator vibrates at the same frequency, vibration having a long wavelength is easily output as compared with a case where an entire surface of the vibrator is fixed to the vibrating body by the fixing portion having poor deformation tolerance. Therefore, in this vibrating device, it is possible to output vibration having a long wavelength while avoiding a transmission loss of vibration between the piezoelectric element and the vibrating body.

The second fixing portions may be separated from the first fixing portion. In this case, it is possible to suppress transmission of vibration having a short wavelength from the vibrator to the vibrating body. Therefore, it is possible to construct a vibrating device that focuses on low sound.

The second fixing portions may be disposed in a pair so as to sandwich the first fixing portion. As a result, the vibrating body can be vibrated in a wider range by the vibration of the vibrator. Therefore, vibration having a long wavelength is more easily output.

The second fixing portions may be disposed so as to overlap edges of the vibrator. As a result, the vibrating body can be vibrated in a wider range. Therefore, vibration having a long wavelength is more easily output.

The second fixing portions may be disposed so as to protrude outward from the edges of the vibrator. As a result, the vibrating body can be vibrated in a wider range by the vibration of the vibrator. Therefore, vibration having a long wavelength is more easily output.

In the second fixing portions, areas of regions located outside the edges of the vibrator may be larger than areas of regions located inside the edges of the vibrator. As a result, the vibrating body can be vibrated in a wider range by the vibration of the vibrator. Therefore, vibration having a long wavelength is more easily output.

The first fixing portion may be located inside the edges of the vibrator while being separated from the edges of the vibrator. In this case, the vibration generated by the vibrator can be transmitted to the vibrating body in a state where a loss is further suppressed.

A thickness of the first fixing portion and a thickness of the second fixing portion may be equal to each other. In this case, the vibrator and the vibrating body are stress-free in an initial state, and ideal vibration can be output with respect to the input.

A facing region between the first fixing portion and the vibrator may be larger than a facing region between the second fixing portion and the vibrator. In this case, since the vibrator is fixed to the vibrating body with a sufficient area, the vibration generated by the vibrator can be transmitted to the vibrating body in a state where the loss is further suppressed.

The first fixing portion may be configured by a double-sided tape, and the second fixing portion may be configured by a sponge and double-sided tapes provided on both surfaces of the sponge. As a result, with a simple configuration, it is possible to generate a difference between the deformation tolerance of the vibrator and the vibrating body by the first fixing portion and the deformation tolerance of the vibrator and the vibrating body by the second fixing portion.

A weight member may be fixed to the vibrator in a state where a center position of the weight member coincides with a center position of the first fixing portion. In this case, the vibration of the vibrator can be amplified by an inertia of the weight member. Therefore, an output of the vibrating device is increased.

### BRIEF DESCRIPTION OF THE DRAWINGS

FIG. 1 is a schematic cross-sectional diagram illustrating a vibrating device according to an embodiment of the present disclosure;

FIG. 2 is a schematic plan diagram illustrating a main part of the vibrating device illustrated in FIG. 1;

FIG. 3A is a schematic diagram illustrating a state during vibration of a vibrating device according to a comparative example;

FIG. 3B is a schematic diagram illustrating a state during vibration of the vibrating device according to the present embodiment;

FIG. 4A is a schematic plan diagram illustrating a main part of a vibrating device according to a modification of the present disclosure;

FIG. 4B is a schematic plan diagram illustrating the main part of the vibrating device according to the modification of the present disclosure;

FIG. 4C is a schematic plan diagram illustrating the main part of the vibrating device according to the modification of the present disclosure; and

FIG. 5 is a diagram illustrating an evaluation test result of an output sound pressure of the vibrating device.

### DETAILED DESCRIPTION

Hereinafter, a preferred embodiment of a vibrating device according to one aspect of the present disclosure will be described in detail with reference to the drawings.

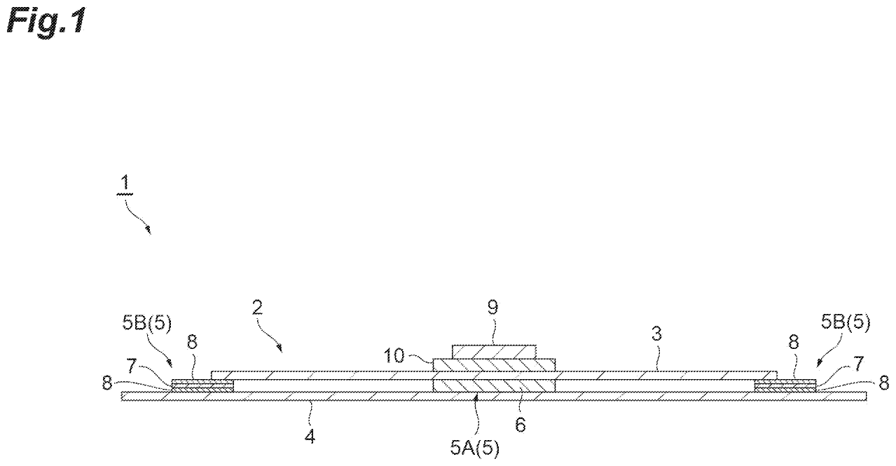

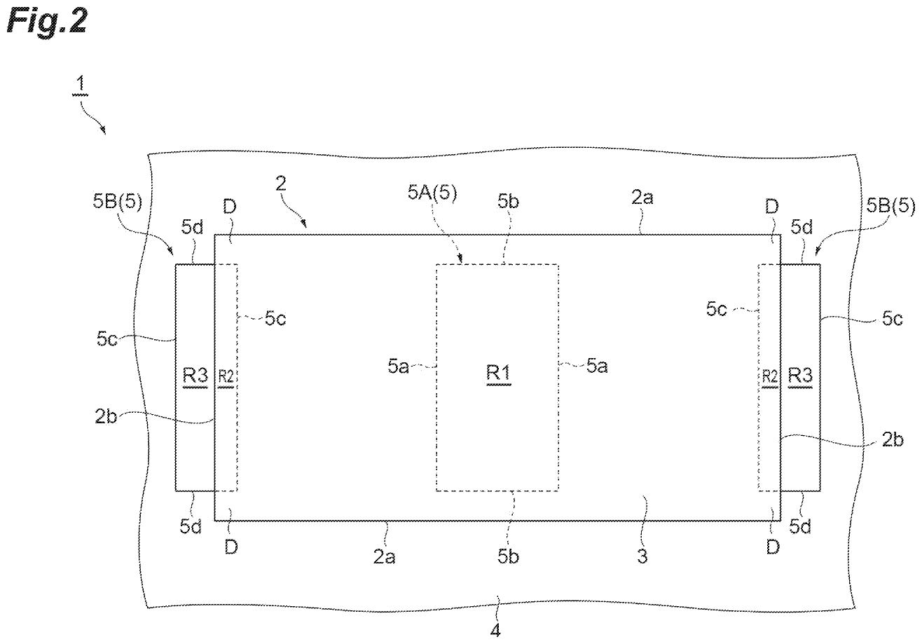

FIG. 1 is a schematic cross-sectional diagram illustrating a vibrating device according to an embodiment of the present disclosure. FIG. 2 is a schematic plan diagram illustrating a main part of the vibrating device illustrated in FIG. 1. In FIG. 2, for convenience of explanation, illustration of a weight member 9 and a fixing portion 10 to be described later is omitted. A vibrating device 1 illustrated in FIGS. 1 and 2 is configured as an acoustic device such as a speaker. The vibrating device 1 is incorporated in an external device such as a headset or a head-up display, for example, and functions as an audio output unit in the device.

As illustrated in FIGS. 1 and 2, the vibrating device 1 includes a vibrator 2 including a piezoelectric element 3 and a vibrating body 4 fixed so as to overlap the vibrator 2 via fixing portions 5. In the present embodiment, the vibrator 2 has a piezoelectric element 3 and a wiring member (not illustrated). The vibrator 2 has, for example, a rectangular shape in plan view. The vibrator 2 may be of either a unimorph type or a bimorph type. In addition to the piezoelectric element 3, the vibrator 2 may further have a diaphragm made of a resin or a metal (diaphragm different from the vibrating body 4).

In the present embodiment, the piezoelectric element 3 has a rectangular parallelepiped shape that is flat in a thickness direction. The rectangular parallelepiped shape may also include a shape in which corner portions and ridge portions are chamfered and a shape in which corner portions and ridge portions are rounded. The piezoelectric element 3 has a piezoelectric element body, an internal electrode, and a pair of external electrodes. The piezoelectric element body is configured by laminating a plurality of piezoelectric layers. Each piezoelectric layer is made of a piezoelectric material such as a piezoelectric ceramic, and is alternately laminated with the internal electrode. Examples of the piezoelectric ceramic material include PZT[Pb(Zr, Ti)O₃], PT(PbTiO₃), PLZT[(Pb, La)(Zr, Ti)O₃], barium titanate (BaTiO₃), and the like.

Each piezoelectric layer is configured by, for example, a sintered body of a ceramic green sheet including the above-described piezoelectric ceramic. In the actual piezoelectric element body, the piezoelectric layers are integrated to such an extent that boundaries between the piezoelectric layers cannot be recognized. A plurality of internal electrodes (not illustrated) are disposed in the piezoelectric element body. Each internal electrode is made of a conductive material. Examples of the conductive material include Ag, Pd, an Ag—Pd alloy, and the like.

The wiring member is a member that electrically couples the piezoelectric element 3 and the external device. As the wiring member, for example, a flexible printed circuit board (FPC) is used. One end of the wiring member is electrically coupled to each of the pair of external electrodes of the piezoelectric element 3. For coupling the wiring member and the external electrode, for example, an anisotropic conductive adhesive can be used. The other end of the wiring member is drawn out from the piezoelectric element and electrically coupled to the external device.

The vibrating body 4 is a plate-like or sheet-like member made of a metal, a resin, paper, or the like, for example. Examples of the metal material include Ni—Fe alloy, Ni, brass, stainless steel, and the like. Examples of the resin material include polyvinyl chloride, polycarbonate, and the like. The planar shape of the vibrating body 4 is not particularly limited, and various shapes such as a rectangular shape and a circular shape can be adopted. An area of the vibrating body 4 is sufficiently larger than an area of the vibrator 2. The vibrating body 4 vibrates when the vibrator 2 (piezoelectric element 3) varies in a thickness direction, and outputs sound based on a predetermined vibration frequency.

The vibrating body 4 is fixed so as to overlap the vibrator 2 via the fixing portion 5. As illustrated in FIG. 2, the fixing portions 5 are configured by a first fixing portion 5A located on the center side and second fixing portions 5B located outside the first fixing portion 5A in plan view of the vibrator 2 and the vibrating body 4.

Deformation tolerance of the vibrator 2 and the vibrating body 4 by the second fixing portions 5B is larger than deformation tolerance of the vibrator 2 and the vibrating body 4 by the first fixing portion 5A. The deformation tolerance here can also be referred to as a restraint force between the vibrator 2 and the vibrating body 4 by the fixing portion 5. In the present embodiment, in order to cause such a difference in the deformation tolerance, a Young's modulus of the first fixing portion 5A is larger than a Young's modulus of the second fixing portion 5B.

As a specific configuration, in the present embodiment, the first fixing portion 5A is configured by a double-sided tape 6, and the second fixing portion 5B is configured by providing double-sided tapes 8 on both surfaces of a member having elasticity such as a sponge 7. In the example of FIG. 2, a thickness of the first fixing portion 5A and a thickness of the second fixing portion 5B are equal to each other. The thickness of the first fixing portion 5A and the thickness of the second fixing portion 5B do not need to strictly coincide with each other, and a difference in thickness based on a manufacturing error or the like can be allowed.

In the second fixing portion 5B, a thickness of the sponge 7 is larger than a total thickness of the double-sided tapes 8 on the both surfaces of the sponge 7. Since the first fixing portion 5A and the second fixing portion 5B have the same thickness, the total thickness of the double-sided tapes 8 on the both surfaces of the sponge 7 is smaller than the thickness of the double-sided tape 6 configuring the first fixing portion 5A.

As illustrated in FIG. 2, in plan view of the vibrator 2 and the vibrating body 4, each of the first fixing portion 5A and the second fixing portion 5B has a rectangular shape. Here, a center position of the first fixing portion 5A coincides with a center position of the vibrator 2, and a center portion of the vibrator 2 is fixed to the vibrating body 4 by the first fixing portion 5A. The first fixing portion 5A is located inside the edges of the vibrator 2 while being separated from the edges of the vibrator 2. An extending direction of long sides 5a of the first fixing portion 5A is along an extending direction of short sides 2b of the vibrator 2, and an extending direction of short sides 5b of the first fixing portion 5A is along an extending direction of long sides 2a of the vibrator 2. The long sides 5a of the first fixing portion 5A are located inside the short sides 2b of the vibrator 2, and the short sides 5b of the first fixing portion 5A are located inside the long sides 2a of the vibrator 2.

In the present embodiment, as illustrated in FIG. 1, the weight member 9 is fixed to the vibrator 2 in a state where the center position of the weight member 9 coincides with the center position of the first fixing portion 5A. The weight member 9 is formed in a plate shape by, for example, a metal or a resin, and is fixed to the side of the vibrator 2 opposite to the vibrating body 4 via the fixing portion 10. In plan view of the vibrator 2 and the vibrating body 4, the weight member 9 has, for example, a rectangular shape slightly smaller than the first fixing portion 5A. Further, the fixing portion 10 has, for example, a rectangular shape having the same dimension as the first fixing portion 5A in plan view of the vibrator 2 and the vibrating body 4, and overlaps the same region as the first fixing portion 5A.

The second fixing portions 5B are disposed in a pair so as to sandwich the central first fixing portion 5A. Here, the second fixing portions 5B are respectively disposed along the short sides 2b of the vibrator 2 in a state of being separated from the first fixing portion 5A, and end portions of the long sides 2a of the vibrator 2 in the extending direction are fixed to the vibrating body 4 by the second fixing portions 5B. The second fixing portions 5B are disposed so as to overlap the edges of the vibrator 2, that is, the short sides 2b, and are disposed so as to protrude outward from the short sides 2b. Between the first fixing portion 5A and the second fixing portions 5B, the vibrator 2 is not fixed by the fixing portion 5 and can freely vibrate.

An extending direction of long sides 5c of the second fixing portions 5B is along the extending direction of the short sides 2b of the vibrator 2, and an extending direction of short sides 5d of the second fixing portions 5B is along the extending direction of the long sides 2a of the vibrator 2. One of the long sides 5c of the second fixing portion 5B is located inside the short side 2b of the vibrator 2, and faces one of the long sides 5a of the first fixing portion 5A with a predetermined interval in the extending direction of the long sides 2a of the vibrator 2. The other of the long sides 5c of the second fixing portion 5B is located outside the short side 2b of the vibrator 2. The short sides 5d of the second fixing portions 5B are located inside the long sides 2a of the vibrator 2 in the extending direction of the short sides 2b of the vibrator 2.

In the present embodiment, the positions of the short sides 5d of the second fixing portions 5B in the extending direction of the short sides 2b of the vibrator 2 are aligned with the positions of the short sides 5b of the first fixing portion 5A. The short sides 5d of the second fixing portions 5B are located inside extension lines of the long sides 2a of the vibrator 2 in the extending direction of the short sides 2b of the vibrator 2. Four corners D of the vibrator 2 do not overlap the second fixing portions 5B in plan view of the vibrator 2 and the vibrating body 4, and these corners D can freely vibrate.

In the example of FIG. 2, a facing region (that is, in plan view of the vibrator 2 and the vibrating body 4, an area RI where the first fixing portion 5A and the vibrator 2 overlap each other) between the first fixing portion 5A and the vibrator 2 is larger than a facing region (that is, in plan view of the vibrator 2 and the vibrating body 4, an area R2 where the second fixing portion 5B and the vibrator 2 overlap each other) between the second fixing portion 5B and the vibrator 2. In the second fixing portions 5B, areas R3 of regions located outside the edges of the vibrator 2 are larger than the areas (that is, the above-described areas R2) of the regions located inside the edges of the vibrator 2.

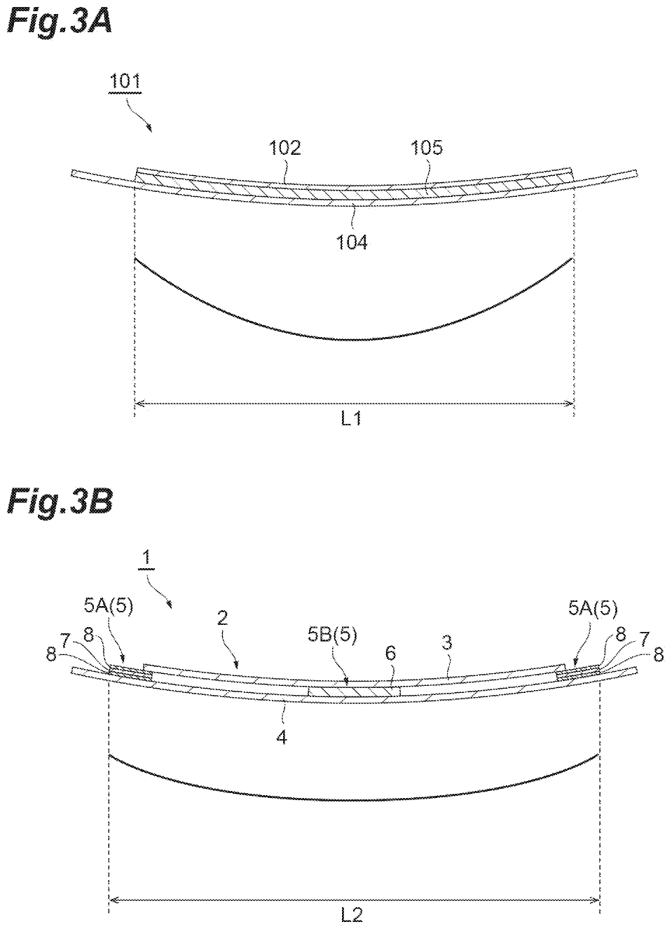

In the vibrating device 1 having the above configuration, the deformation tolerance of the first fixing portion 5A on the center side is suppressed, so that vibration generated in the vibrator 2 can be transmitted to the vibrating body 4 in a state where a loss is suppressed. On the other hand, since the deformation tolerance of the outer second fixing portions 5B are secured, the vibrating body 4 can be vibrated in a wider range. For example, as illustrated in FIG. 3A, in a vibrating device 101 of a comparative example in which an entire surface of a vibrator 102 is fixed to a vibrating body 104 by a fixing portion 105 (double-sided tape), the restraint force of the vibrator 102 on the vibrating body 104 by the fixing portion 105 becomes strong. Therefore, when the vibrator 102 vibrates at a predetermined vibration frequency, the vibrating body 104 vibrates with a large curvature in a range L1 similar to that of the vibrator 102, and it is difficult to output vibration having a long wavelength.

On the other hand, in the vibrating device 1 of the present embodiment, as illustrated in FIG. 3B, while the center portion of the vibrator 2 is strongly restrained by the first fixing portion 5A, the restraint force of both end portions of the vibrator 2 is weakened as compared with the restraint force of the center portion, by the second fixing portions 5B having larger deformation tolerance than the first fixing portion 5A. As a result, even when the vibrator 2 vibrates at the same frequency as in the case of FIG. 3A, the vibrating body 104 vibrates with a small curvature in a range L2 wider than the vibrator 102, and vibration having a long wavelength is easily output. Therefore, in the vibrating device 1, it is possible to output vibration having a long wavelength while avoiding a transmission loss of vibration between the piezoelectric element 3 and the vibrating body 4.

In the present embodiment, the second fixing portions 5B are separated from the first fixing portion 5A. According to such a configuration, it is possible to suppress transmission of vibration having a short wavelength from the vibrator 2 to the vibrating body 4. Therefore, it is possible to construct the vibrating device 1 that focuses on low sound.

In the present embodiment, the second fixing portions 5B are disposed in a pair so as to sandwich the first fixing portion 5A. The second fixing portions 5B are disposed so as to overlap the edges of the vibrator 2, and are disposed so as to protrude outward from the edges of the vibrator 2. As a result, the vibrating body 4 can be vibrated in a wider range by the vibration of the vibrator 2. Therefore, vibration having a long wavelength is more easily output.

In the present embodiment, in the second fixing portions 5B, the areas R3 of the regions located outside the edges of the vibrator 2 are larger than the areas R2 of the regions located inside the edges of the vibrator 2. With such a configuration, the vibrating body 4 can be vibrated in a wider range. Therefore, vibration having a long wavelength is more easily output.

In the present embodiment, the first fixing portion 5A is located inside the edges of the vibrator 2 while being separated from the edges of the vibrator 2. According to such a configuration, the vibration generated by the vibrator 2 can be transmitted to the vibrating body 4 in a state where a loss is further suppressed.

In the present embodiment, the thickness of the first fixing portion 5A and the thickness of the second fixing portion 5B are equal to each other. As a result, the vibrator 2 and the vibrating body 4 are stress-free in an initial state, and ideal vibration can be output with respect to the input.

In the present embodiment, the facing region between the first fixing portion 5A and the vibrator 2 may be larger than the facing region between the second fixing portion 5B and the vibrator 2. As a result, since the vibrator 2 is fixed to the vibrating body 4 with a sufficient area, the vibration generated by the vibrator 2 can be transmitted to the vibrating body 4 in a state where the loss is further suppressed.

In the present embodiment, the first fixing portion 5A is configured by the double-sided tape 6, and the second fixing portion 5B is configured by the sponge 7 and the double-sided tapes 8 and 8 provided on the both surfaces of the sponge 7. As a result, with a simple configuration, it is possible to generate a difference between the deformation tolerance of the vibrator 2 and the vibrating body 4 by the first fixing portion 5A and the deformation tolerance of the vibrator 2 and the vibrating body 4 by the second fixing portion 5B.

In the present embodiment, the weight member 9 is fixed to the vibrator 2 in a state where the center position of the weight member 9 coincides with the center position of the first fixing portion 5A. As a result, the vibration of the vibrator 2 can be amplified by an inertia of the weight member 9. Therefore, an output of the vibrating device 1 is increased.

### Modification

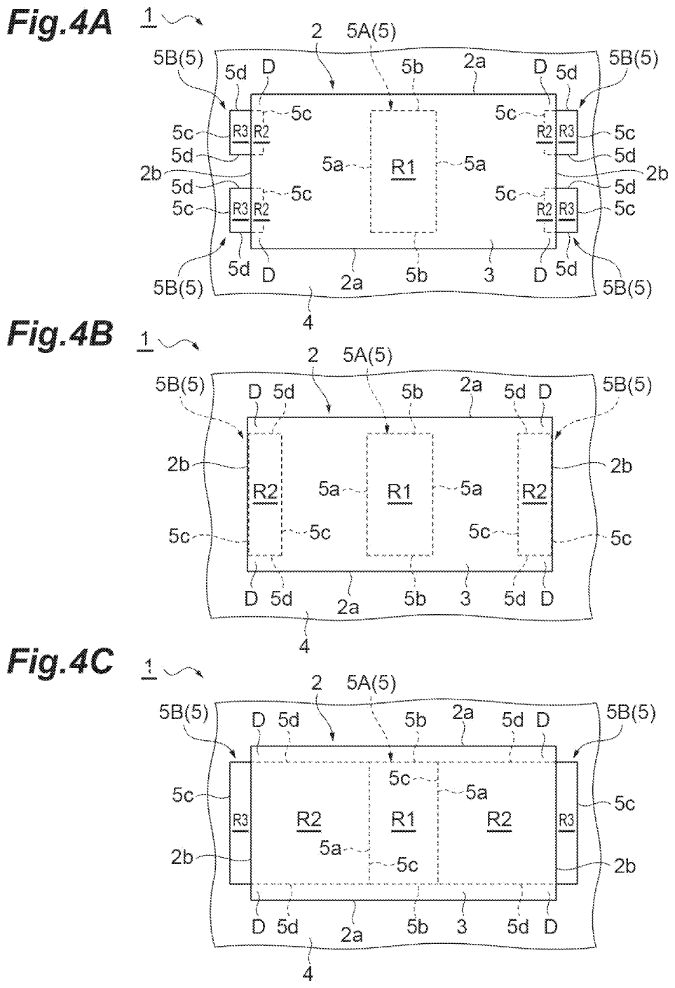

The present disclosure is not limited to the above-described embodiment. For example, in the above embodiment, the second fixing portions 5B extend along the extending direction of the short sides 2b of the vibrator 2, but as illustrated in FIG. 4A, the second fixing portions 5B may be divided into a plurality of portions in the extending direction of the short sides 2b of the vibrator 2. In addition, the second fixing portions 5B are not necessarily disposed so as to protrude outward from the edges of the vibrator 2, and as illustrated in FIG. 4B, the other of the long sides 5c of the second fixing portions 5B may coincide with the short side 2b of the vibrator 2 in plan view of the vibrator 2 and the vibrating body 4. Although not illustrated, the other of the long sides 5c of the second fixing portions 5B may be located inside the short side 2b of the vibrator 2.

In addition, the second fixing portion 5B is not necessarily separated from the first fixing portion 5A, and as illustrated in FIG. 4C, the long side 5a of the first fixing portion 5A may be in contact with one of the long sides 5c of the second fixing portion 5B. In the aspect of FIG. 4C, the facing region between the second fixing portion 5B and the vibrator 2 is larger than the facing region between first fixing portion 5A and the vibrator 2, but such an aspect can also be included in the present disclosure.

### Evaluation Test of Vibrating Device

In this evaluation test, samples of vibrating devices according to Examples and Comparative Examples were prepared, and an output sound pressure level (SPL) in each sample was measured. In Example 1, similarly to the aspect illustrated in FIG. 2, the vibrator including the piezoelectric element was fixed to the vibrating body by the first fixing portion at the center and the pair of second fixing portions sandwiching the first fixing portion. The first fixing portion was configured by a double-sided tape, and the second fixing portion was configured by a sponge and double-sided tapes provided on both surfaces of the sponge. In Example 2, the same configuration as that of Example 1 in which a piezoelectric element having a resin diaphragm was used as the vibrator was adopted. In Comparative Example 1, as in the aspect illustrated in FIG. 3A, the entire surface of the vibrator including the piezoelectric element was fixed to the vibrating body with the double-sided tape. In the measurement, an input voltage was 12 Vpp, and a microphone distance was 10 cm.

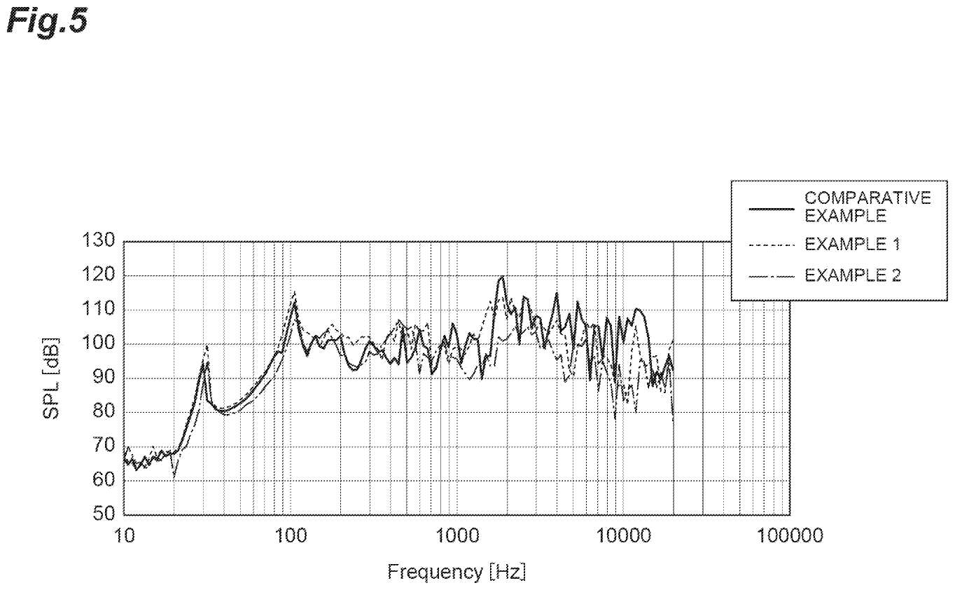

FIG. 5 is a diagram illustrating an evaluation test result of the output sound pressure of the vibrating device. As illustrated in FIG. 5, in the frequency band of 100 Hz to 1000 Hz, the output sound pressures of the vibrating devices of Examples 1 and 2 were improved by about 20 dB at the maximum as compared with the vibrating device of the comparative example. From this result, it was confirmed that the configuration in which the deformation tolerance of the vibrator and the vibrating body by the second fixing portions is made larger than the deformation tolerance of the vibrator and the vibrating body by the first fixing portion as in the present disclosure contributes to the output of vibration having a long wavelength while avoiding a transmission loss of vibration between the piezoelectric element and the vibrating body.

What is claimed is:

1. A vibrating device comprising:
a vibrator including a piezoelectric element; and
a vibrating body fixed so as to overlap the vibrator via fixing portions, wherein
the fixing portions have a first fixing portion located on a center side and second fixing portions located outside the first fixing portion in plan view of the vibrator and the vibrating body, and
deformation tolerance of the vibrator and the vibrating body by the second fixing portion is larger than deformation tolerance of the vibrator and the vibrating body by the first fixing portion.

2. The vibrating device according to claim 1, wherein the second fixing portions are separated from the first fixing portion.

3. The vibrating device according to claim 1, wherein the second fixing portions are disposed in a pair so as to sandwich the first fixing portion.

4. The vibrating device according to claim 1, wherein the second fixing portions are disposed so as to overlap edges of the vibrator.

5. The vibrating device according to claim 1, wherein the second fixing portions are disposed so as to protrude outward from edges of the vibrator.

6. The vibrating device according to claim 5, wherein in the second fixing portions, areas of regions located outside the edges of the vibrator are larger than areas of regions located inside the edges of the vibrator.

7. The vibrating device according to claim 1, wherein the first fixing portion is located inside edges of the vibrator while being separated from the edges of the vibrator.

8. The vibrating device according to claim 1, wherein a thickness of the first fixing portion and a thickness of the second fixing portion are equal to each other.

9. The vibrating device according to claim 1, wherein a facing region between the first fixing portion and the vibrator is larger than a facing region between the second fixing portion and the vibrator.

10. The vibrating device according to claim 1, wherein
the first fixing portion is configured by a double-sided tape, and
the second fixing portion is configured by a sponge and double-sided tapes provided on both surfaces of the sponge.

11. The vibrating device according to claim 1, wherein a weight member is fixed to the vibrator in a state where a center position of the weight member coincides with a center position of the first fixing portion.
